(19) United States
(12) Patent Application Publication
(10) Pub. No.: US 2005/0258954 A1
(43) Pub. Date: Nov. 24, 2005

(54) Apparatus and method for providing motion actuated light

(76) Inventor: Thomas R. Ruskin, Swampscott, MA (US)

Correspondence Address: CHOATE, HALL & STEWART LLP, TWO INTERNATIONAL PLACE, BOSTON, MA, 02110, US

(21) Appl. No.: 11/077,101

(22) Filed: Mar. 10, 2005

Related U.S. Application Data
(60) Provisional application No. 60/552,178, filed on Mar. 11, 2004.

(51) Int. Cl. G08B 23/00

(52) U.S. Cl. 340/527; 340/541; 362/802

(57) ABSTRACT

Functionally, the present invention illuminates an otherwise dark room when motion is detected by a motion sensor, causing the switch to close and the illumination means to light and stay lit for a set time after the motion sensor does not detect motion. In one aspect, the motion actuated lighting device of the present invention is enclosed in a housing which contains: a power source, illumination means, motion sensor, electrical circuit, and time delay means to turn off the light if the motion sensor no longer detects motion. The device may further consist of a light sensor or photocell and the associated circuitry for nighttime operation. In another aspect of the invention, the elements of the lighting device are modular. For example, while the motion sensor may be located in a doorway or at the foot of a bed, the illumination means may be located in another room, such as a bathroom, and the photocell may be located close to a window.

### PRIORITY INFORMATION

This application claims priority to U.S. Provisional Application No. 60/552,178, filed on Mar. 11, 2004.

### FIELD OF INVENTION

The present invention is directed towards an apparatus and method for providing motion actuated light.

### BACKGROUND OF INVENTION

Commercial establishments and in particular, hotels, inns and guest houses, have a need for providing night lights in their guest rooms. Guests of such establishments may find themselves unfamiliar with their surroundings and could have trouble maneuvering around the room without lighting. Furthermore, due to their unfamiliarity with the room or poor room design, the light switch may be difficult to find or reach. Therefore it is one aspect of the present invention to provide a motion actuated lighting device for commercial establishments. Other aspects and embodiments of the invention are appropriate for both in-home applications and use for travel.

Motion actuated lighting devices allow the lighting device to activate or illuminate without a patron reaching or finding the corresponding light switch. The motion sensing feature on most lights is a passive system that detects infrared energy. These sensors are known as “passive infrared detectors” or “pyroelectric sensors”. A sensor that can detect a human being is constructed to be sensitive to the temperature of a human being. Humans, having a skin temperature of about 93 degrees F., radiate infrared energy with a wavelength of between 9 and 10 micrometers. Therefore, the sensors are typically sensitive in the range of 8 to 12 micrometers.

The motion sensors themselves are simple electronic components in which the infrared light bumps electrons off a substrate. These electrons can then be detected and amplified into a signal. The electronics package attached to the sensor will look for a fairly rapid change in the amount of infrared energy it detects, so when a person walks by, the amount of infrared energy in the field of view changes rapidly and is easily detected.

Motion activated light fixtures generally utilize infrared sensors, together with an optical collecting and focusing means, such as a system of Fresnel lenses. The aggregate of the individual fields of view of the multiple Fresnel lenses defines the overall field of view of the device. The terms “motion detection”, “motion sensor” or “activated by motion” herein refer to the detection of an infrared source in the field of view of the light fixture.

Most commercially available night lights are small electric lights with a connecting end, which includes a pair of prongs for plugging into a standard wall outlet, and an illuminating end, containing a light bulb at a 90 degree angle to the connecting end. These lights are intended to be simply plugged into and removed from standard wall outlets by the user as needed. However, it is these kinds of night lights provided in commercial establishments that patrons may, and frequently do, remove from the premises. Providing night lights as fungible items becomes expensive.

One solution to this problem suggested by the prior art is to permanently affix the night light fixture to a standard wall outlet. The night light itself is nonremovable, as provided in U.S. Pat. No. 4,931,911. However, in most establishments, and in particular hotels, inns, offices and houses, there are limited electrical outlets remaining for an occupant to use after all the appliances included within the room are plugged in. Therefore it is one aspect of the present invention to provide night lights in establishments that can be affixed so that they are nonremoveable and do not occupy an outlet.

Known recessed lighting fixtures are typically installed in hung ceilings and are electrically connected via a junction box located within the ceiling. The fixture's housing and accessories are usually permanently installed within the ceiling structure. Installation of such fixtures necessitates obtaining access to awkward areas within the ceiling for electrical connections between the junction box and the lighting fixture. With currently available designs, installation and wiring of both the fixture and the junction box becomes difficult due to the presence of thermal insulation, electrical wiring, and other conduits. Also, any wiring modifications or changes require that part of the ceiling be temporarily removed to allow access to a junction box which, in many cases, is mounted at an inaccessible position within the ceiling. Even in cases where the junction box is directly attached to the housing, the entire fixture must be dismounted and unassembled to make wiring changes when there is limited free space immediately surrounding the housing. Under such circumstances, temporary removal of the ceiling or portions thereof are necessary. Accordingly, it is an aspect of the invention to provide a ceiling mounted, motion actuated lighting fixture that is easy to install, repair and replace. It is another aspect of the invention to provide a motion actuated lighting fixture that, when installed, does not necessitate electrical wiring installation or rewiring.

### SUMMARY OF THE INVENTION

In one aspect, the motion actuated lighting device of the present invention is enclosed in a housing which contains: a power source, illumination means, motion sensor, electrical circuit, and time delay means to turn off the light if the motion sensor no longer detects motion. The device may further consist of a light sensor or photocell and the associated circuitry for nighttime operation.

In one embodiment, the present invention illuminates an otherwise dark room when motion is detected by a motion sensor, causing the electronic circuit to close and the illumination means to light and stay lit for a set time after the motion sensor does not detect motion. The enclosure may be mounted and secured in any area a night light would be appropriate; for example, in the ceiling, in the wall or along a corridor, or adjacent to or embedded in a piece of furniture. The housing may further comprise a locking mechanism and be locked into a structure or otherwise secured into place.

In another aspect of the invention, the elements of the lighting device are modular. In this aspect, one or more of the power source, illumination means, motion sensor, electrical circuit, time delay means, and photocell may be located outside of the housing. For example, while the motion sensor may be located in a doorway or at the foot of a bed, the illumination means may be located in another room, such as a bathroom, and the photocell may be located close to a window.

In yet another aspect, the present invention is attached to and/or powered by a fixed or portable electronic device, such as a bedside lamp or portable alarm clock.

### BRIEF DESCRIPTION OF THE DRAWING

FIG. 1 is an illustration of a side view of one aspect of the motion actuated lighting device of the present invention; and

FIG. 2 is a schematic of another aspect of the motion actuated lighting device, wherein the lighting device is located inside the base of another lighting device.

### DETAILED DESCRIPTION OF THE DRAWING

Different aspects of the present invention functionally provide a motion actuated lighting device that is easy to install, access, repair and replace, and may be modular to facilitate use and lighting access for different establishment or home layouts.

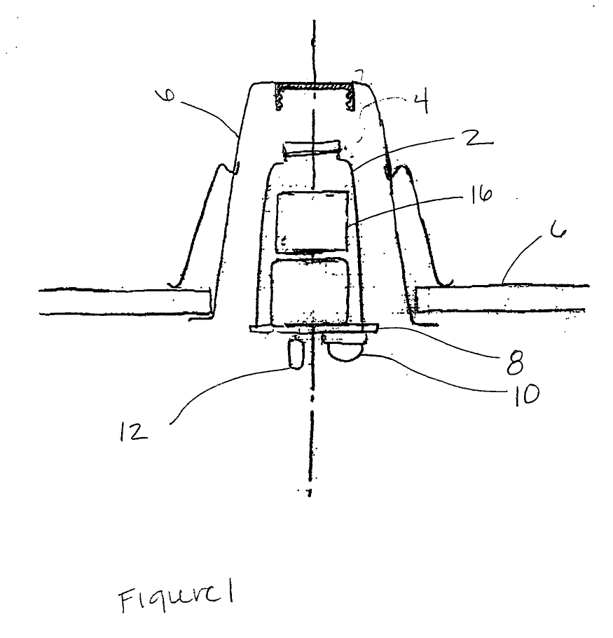

For example, in a first aspect, as illustrated in FIG. 1, the motion actuated lighting device of the present invention includes a housing 2, which may be closed, partially open, or open, and further includes one or more of an electrical circuit 8, motion sensor 10, illumination means 12, and time delay means (not shown), wherein the power source 16, motion sensor 10, illumination means 12 and time delay means are all connected by the electrical circuit 8. When the motion sensor 10 detects motion, the electrical circuit 8 causes the illumination means 12 to illuminate. When the motion sensor 10 does not detect motion, the electrical circuit 8 turns off the illumination means 12 after a time delay controlled by the time delay means.

In one embodiment, the power source 16 and time delay means are contained within the housing 2. The motion sensor 10 is placed separate from, but still connected to, the other components so as to “aim” the motion sensor 10 in a certain direction. In this embodiment, the motion sensor 10 is positioned to detect motion from a specific portion of an area, and activates the illumination means 12 when motion is sensed in the specific area. In another embodiment, the illumination means 12 is placed separate from, but still connected to, the other components so as to illuminate a certain area or aim the illumination to light a predetermined and specific area. In yet another embodiment, both the illumination means 12 and motion sensor 10 are placed separate from, but still connected to, the other components. For example, in an embodiment located within a hotel bedroom, the housing 2 with the power source 16, electrical circuit 8, and time delay means may be constructed inside a bedside table. The motion sensor 10 may be placed a selected distance from the floor, so that a patron might only activate the sensor if he places a foot on the ground next to the bed. The illumination means 12 may also be located at the bed base-board or directly outside the bathroom door, so that the illumination means 12 illuminates the way to the bathroom from the bedroom without disturbing a co-patron. The illumination means 12 may be accessible to and adjusted by the patron, e.g., by adjusting a slidable cover over a portion of the illumination means 12, or removing one or more bulbs in an array of bulbs. Should the lighting device further include a resistor or a rheostat device (not shown), the brightness of the illumination means 12 may also be changed by adjusting the voltage supplied to the illumination means 12 and by adjusting the resistor or rheostat device.

The lighting device as depicted in FIG. 1 may further comprise a mountable cover (not shown) engageable with the housing 2 for enclosing the housing 2. The mountable cover may be made out of any suitable transparent material and may protect against objects inadvertently coming into contact with any of the illumination means 12, motion sensor 10, time delay means, power source 16 or electrical circuit 8 that may be enclosed. In one embodiment, the cover plate is a textured cover plate, wherein the cover plate diffuses the light of the illumination means 12, resulting in a “softer” light emanating from the lighting device of the present invention. In another embodiment, the cover plate includes a doping of a phosphorescent material so that the cover plate glows in the dark when energized by illumination. In other embodiments, the cover is a combination of transparent and opaque material. Wherein only a portion of the plate is opaque, the plate may be positioned to allow the opaque (or alternatively the transparent) section to control the amount of light diffused or the field of motion sensed. The cover plate may be designed in accordance with the aesthetics of its location.

In another embodiment, the invention further comprises a means for locking 4 the housing 2 to a structure 6. The locking means 4 may be a mechanical locking device whereby the locking means 4 does not separate from the structure 6 only when force is applied in line with the lighting device and in the opposite direction of the structure 6. For example, if the lighting device is secured to the ceiling, the locking means 4 does not unlock when a user pulls on the housing 2 directly downward in the direction towards the floor. The user may have to turn, twist, push, pull or apply some indirect force to the locking means 4 in combination with turning, twisting, pushing or pulling, to release the housing 2 from the structure 6. The housing 2 may have tabs adapted to fit within the structure 6. The user may have to rotate the housing 2 to release the tabs from the structure 6. Alternatively, the user may have to apply a “squeezing” force to the housing 2 in order to release the tabs from the structure 6.

Furthermore, the mechanical constructions for removeably locking the housing 2 may have several attachment points and the amount of light diffused or field of motion sensed may depend on which attachment point is utilized. For example, if the housing 2 has six pins around its circumference, and a high-hat structure has two male receptacles to accept two of the six pins, the rotating of the housing 2 to accept one pair of pins may angle the motion sensor 10 towards a different line of sight than the rotation of the housing 2 to accept a different pair of pins. Additionally, the rotation of the housing 2 to accept one pair of pins may angle, or change the amount of light diffused. Alternatively, the housing 2 may be permanently or semi-permanently attached to the structure 6 by screws, pins, glue, tape, nails, similar materials or any equivalent thereof. Different mechanical constructions for removeably locking the housing 2 will become apparent to those skilled in the art.

The structure 6 may be permanently fixed, such as a ceiling, wall, lighting fixture, or floor. In other embodiments, the structure 6 may also be removeable, such as a piece of furniture or a fixed or portable electronic device. Lighting fixtures may include, but are not limited to, track mounting onto ceiling or walls, recessed ceiling mounted (or “high-hat”) fixtures, wall mounted sconces or other decorative fixtures. A piece of furniture may include, but is not limited to, a vanity mirror, toilet, bedside table, bed baseboard or desk. An electrical fixture or portable electronic device may include, but is not limited to, a television, alarm clock, table lamp, a floor lamp or any electronic appliance found in a place of permanent or temporary residence. The structure 6 may be located inside a building, room, hallway, closet, or partially enclosed space. Alternatively, the structure 6 may be located outside of a building.

The power generated by the power source 16 of the present invention may be direct current (DC) or alternating current (AC). Different embodiments wherein the power source generates DC power incorporate all types of batteries, including but not limited to, AAA, AA, C, D, 9V, nickel cadmium, nickel metal hydride, lithium ion, or sealed lead acid. Batteries used with the lighting devices of the present invention may also be rechargeable. One advantage to the power source 16 being a battery, is that the lighting device need not be permanently installed into the structure 6. In such an embodiment, there would be no need for wiring installation or rewiring of the lighting device, a junction box, or the structure 6. For example, the motion actuated lighting device of this embodiment may be installed into an existing ceiling without the need to remove significant portions of the ceiling or rewire the room. Embodiments powered by AC may be hardwired, or may include an AC/DC converter (not shown) so that the lighting device is powered by an AC power source (such as an outlet fixture) converted into DC voltage. The motion-actuated lighting device may attach to the converter and the converter may attach directly to the power source. For example, the lighting device and the converter may directly attach to, and be powered by, a high-hat light bulb receptacle. The AC power source may further charge a DC power source.

If the structure 6 is a fixed or portable electronic device and the power source 16 is an AC outlet fixture, the electronic device may include an AC transformer (not shown) so that the AC power may be shared between the motion-actuated lighting device and the fixed or portable electronic device. The fixed or portable electronic device may be another lighting fixture, portable lighting device, or any other AC powered, affixed or portable device.

In another embodiment, the means for illumination 12 may be an incandescent bulb or at least one light emitting diode. Other means for illumination 12 might include but are not limited to: vacuum, krypton or halogen bulbs, fluorescent, compact fluorescent, high density definition (“HID”), or quartz halogen lighting. Bulbs may be removed from the lighting device to save power and bulb life, and may incorporate a means for fading, so that the illumination decreases from light to dark (on to off) rather than instantaneously changing from light to dark. For example, wherein the illumination means 12 is an array of light emitting diode, one or more of the light emitting diodes may be removed from the array to save bulbs and power. Furthermore, the illumination means 12 may be appropriately angled or covered to eliminate glare, depending upon the location, brightness and purpose or use of the illumination means 12. In yet another embodiment, the means for illumination 12 produces low level illumination.

Light fixtures with integral motion detectors and which do not protrude from the light bulb or bulbs have previously been designed so that the lens is placed to avoid viewing interference from other parts of the fixture. See for example, the wall light fixture U.S. Pat. No. 5,282,118 and U.S. Pat. No. 5,662,411, herein incorporated by reference. In one embodiment, the motion sensor 10 is designed so that the lens is placed to avoid viewing interference from other parts of the fixture. In another embodiment, placement or “calibration” of the illumination means 12 and the motion sensor 10 of the present invention allows the motion sensor to be “aimed” in a certain direction or limits the degree of motion sensing. For example, in one embodiment, a motion sensor 10 is placed adjacent to a row of five LEDs 12 thereby limiting the ability for the motion sensor 10 to “sense” or “see” the area blocked by the LEDs 12. The lighting device may be placed in a bedroom, for example, creating a blind spot in the direction of the bed, and therefore allow the motion sensor 10 to only sense motion if a patron or user leaves the bed during the night. Further advantages of this intentional placement and, therefore, the creation of intentional blind spots of the motion sensor 10 will become apparent to those skilled in the art.

Alternatively, some embodiments of the present invention hide or camouflage the motion sensor 10. For example, a motion sensor 10 protruding from a lighting device in a hotel room or bathroom (looking like an exposed camera lens) may unnerve patrons. Therefore, it may be advantageous to further comprise an additional cover, to recess the motion sensor 10 or lighting device behind a cover, or to incorporate the protruding motion sensor 10 into the design of the device so that the sensor 10 does not look like a privacy-invading mechanism.

The lighting device of the present invention may further comprise a light sensor (not shown) or photocell for detecting ambient light levels. In this aspect, the power source 16, motion sensor 10, illumination means 12, time delay means and light sensor are all connected by the electrical circuit 8. In one embodiment of this aspect, when the motion sensor 10 detects motion and the light sensor detects darkness, the electrical circuit 8 causes the illumination means 12 to illuminate. When the motion sensor 10 does not detect motion or the light sensor does not detect darkness, the electrical circuit 8 turns off the illumination means 12 after a time delay controlled by the time delay means. Alternatively, the illumination means 12 may be automatically controlled by means of photocell or sensor for on and off switching. The means for illumination 12 will be switched on when the ambient light around the device decreases to a predetermined level. Generally, this level will be at the point where persons begin to find it difficult to make out the objects around them. The light sensor will short the current during daylight, to keep the illumination means 12 off even when the motion sensor 10 detects motion.

The lighting device of the present invention may further comprise an on/off switch (not shown) to control the illumination means 12 and/or a dimming switch to control the brightness of the illumination means 12. An “instant kill” mechanism may be further incorporated so that a person may instantly deactivate the motion-actuated lighting device. The device would stay deactivated until physically turned back on, or until the device is otherwise reset.

In addition, the present invention may further include an automatic or manual reset mechanism (not shown) wherein if the device is manually turned off, it may be reset after a designated time period. In other embodiments, the device reset mechanism is controlled by another system that may be reset. For example, in a hotel room setting, the card key code will be reset upon the arrival of a new guest. Therefore, the lighting device of the present invention employed in that hotel room may further include a mechanism or device to “sync” the lighting device reset with the card key code reset process.

In yet another embodiment of an aspect in which the power source 16 is an AC outlet fixture, the lighting device could further include a battery. The AC power source may charge the battery. An alternate embodiment may include an AC/DC converter. In this embodiment, the lighting device is powered by the AC power source converted into DC voltage.

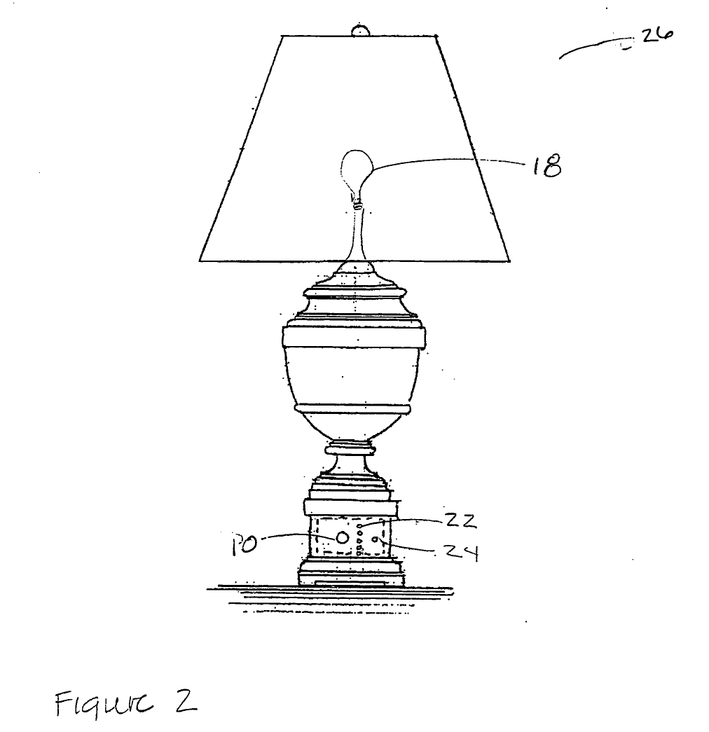

In another aspect, the present invention, as depicted in FIG. 2, is a portable lighting device 26 comprising a power source (not shown) and a first illumination means 18 powered by the power source. The portable lighting device 26 further includes an electrical circuit (not shown), a motion sensor 10, a second illumination means 22 and a time delay means (not shown). The motion sensor 10, second illumination means 22, and time delay means are all connected by the electrical circuit and contained within the portable lighting device 26, so that when the motion sensor 10 detects motion, the electrical circuit causes the second illumination means 22 to illuminate. When the motion sensor 10 does not detect motion, the electrical circuit turns off the second illumination means 22 after a time delay set by the time delay means.

In one embodiment of this aspect, the portable lighting device 26 further comprises a first/second illumination switch (not shown). Here the switch is a control for the first 18 or second illumination means 22. The portable lighting device 26 may also include an on/off switch (not shown). When the first/second illumination switch is set to control the first illumination means 18, the on/off switch is an on and off control for the first illumination means 18. When the first/second illumination switch is set to control the second illumination means 22, the on/off switch is an on and off control for the second illumination means 22. In another embodiment, when the first/second switch is set to control the first illumination means 18, the voltage from the power source to power the first illumination means 18 is higher than when the switch is set to control the second illumination means 22. In yet another embodiment, the lighting fixture further comprises a transformer (not shown). In this case, the power may be shared between the first illumination means 18 and the second illumination means 22. The portable lighting device 26 may also include a dimming switch (not shown). Here, when the first/second switch is set to control the first illumination means 18, the dimming switch controls the brightness of the first illumination means 18. When the first/second switch is set to control the second illumination means 22, the dimming switch controls the brightness of the second illumination means 22.

In another embodiment of this aspect, the lighting device 26 further comprises a light sensor 24 for detecting ambient light levels. The motion sensor 10, second illumination means 22, time delay means, and light sensor 24 are all connected by the electrical circuit and at least one of these sensors and/or means are contained within the portable lighting device 26. When the motion sensor 10 detects motion and the light sensor 24 detects darkness, the electrical circuit causes the second illumination means 22 to illuminate. When the motion sensor 10 does not detect motion or the light sensor 24 does not detect darkness, the electrical circuit turns off the second illumination means 22 after a time delay controlled by the time delay means. The lighting device 26 may further comprise a light sensor 24 for detecting ambient light levels so that when the light sensor 24 detects darkness, the electrical circuit causes the second illumination means 22 to illuminate and when the light sensor 24 does not detect darkness, the electrical circuit turns off the second illumination means 22 after a time delay controlled by the time delay means.

The illustrated embodiments have been set forth only for the purposes of example, and should not be taken as limiting the invention. Therefore, it should be understood, that within the scope of the appended claims, the invention may be practiced other than specifically described herein.

### EXEMPLIFICATION

The ceiling mounted, recessed lighting fixture was comprised of a frame with some means for being secured to the structural supports of the ceiling. The housing was a plastic tube and the power source was adapted to sit inside the housing. The electrical circuit, motion sensor, illumination means, and time delay means was adapted to sit on top of, and adjacent to, a first opening of the plastic tube housing. The second opening, or opposite end, of the plastic tube housing was adapted to removeably lock into the frame of a recessed lighting fixture.

The locking means of the housing had teeth, or grooves, to engage corresponding teeth or grooves with the structure. The locking means performed much like a child-proof cap on a medicine bottle. The housing had a projecting region which contained the arcurate slot. As the housing was rotated, the projecting region with the arcurate slot rotated into the structure teeth, or grooves. The engagement of teeth between the arcuate slot removeably locked the housing to the structure. To unlock the housing, it was rotated and at the same time pushed up and into the structure, releasing the projecting region of the housing with the accurate slot from the structure.

The lighting device was powered by four C cell batteries. The motion sensor, light sensor, and time delay means were combined into one pre-manufactured unit. Five light emitting diodes provided the illumination. The batteries were contained within the housing. The motion sensor, light sensor, time delay means, and light emitting diodes were all connected by an electrical circuit and adapted to sit on top of, and adjacent to, the first opening of the housing. The housing was secured to the ceiling by the locking mechanism located at its opposite end.

When the motion sensor detected motion and the light sensor detected darkness, the electrical circuit caused the LEDs to light. When the motion sensor did not detect motion or the light sensor did not detect darkness, the electrical circuit turned off the LEDs after approximately 15-20 seconds. The motion sensor was placed directly next to the LEDs and so it has a blind spot of approximately 100-120 degrees.

1. A motion actuated lighting device, comprising:
a housing;
a power source;
an electrical circuit;
a motion sensor;
an illumination means; and
a time delay means,
wherein at least one of the power source, electrical circuit, motion sensor, illumination means and time delay means are enclosed within the housing,
and wherein the power source, motion sensor, illumination means and time delay means are connected by the electrical circuit, such that when the motion sensor detects motion, the electrical circuit causes the illumination means to illuminate and when the motion sensor does not detect motion, the electrical circuit turns off the illumination means after a time delay controlled by the time delay means.

2. The lighting device of claim 1, wherein the power generated by the power source is direct current (DC).

3. The lighting device of claim 2, wherein the power source is at least one battery.

4. The lighting device of claim 3, wherein the at least one battery is selected from a group consisting of AAA, AA, C, D, 9V, nickel cadmium, nickel metal hydride, lithium ion, sealed lead acid or combinations thereof.

5. The lighting device of claim 3, wherein the at least one battery is rechargeable.

6. The lighting device of claim 1, wherein the power generated by the power source is alternating current (AC).

7. The lighting device of claim 1, further comprising a means for securing the housing to a structure.

8. The lighting device of claim 7, wherein the structure is selected from a group consisting of a building, ceiling, wall, floor, piece of furniture, fixed electronic device, portable electronic device, and components thereof.

9. The lighting device of claim 7, wherein the structure is a lighting fixture.

10. The lighting device of claim 9, wherein the lighting fixture is selected from a group consisting of track-mounted, recessed, and wall-mounted.

11. The lighting device of claim 1, further comprising a mountable cover engageable with the housing, for enclosing the housing.

12. The lighting device of claim 1 1, wherein the mountable cover is made of a material selected from the group consisting of transparent, colored, frosted, textured, flat, clear, opaque and combinations thereof.

13. The lighting device of claim 11, wherein the mountable cover includes a doping of phosphorescent material.

14. The lighting device of claim 1, further comprising an AC/DC converter, wherein the power generated by the power source is AC, and wherein the AC power is converted into DC power.

15. The lighting device of claim 6, further comprising a DC power source, wherein the AC power source charges the DC power source.

16. The lighting device of claim 1, wherein the illumination means is selected from a group consisting of incandescent bulbs, light emitting diodes (LEDs), vacuum bulbs, krypton bulbs, halogen bulbs, fluorescent lighting, compact fluorescent lighting, high density definition lighting and quartz halogen lighting.

17. The lighting device of claim 1, wherein the illumination means produces low level illumination.

18. The lighting device of claim 1, wherein the illumination means further includes a means for fading, wherein the illumination decreases from on to off, or increases from off to on.

19. The lighting device of claim 1, further comprising a light sensor for detecting ambient light level, wherein the power source, motion sensor, illumination means, time delay means and light sensor are connected by the electrical circuit such that when the motion sensor detects motion and the light sensor detects darkness, the electrical circuit causes the illumination means to illuminate and when the motion sensor does not detect motion or the light sensor does not detect darkness, the electrical circuit turns off the illumination means after a time delay set by the time delay means.

20. The lighting device of claim 1, further comprising a light sensor for detecting ambient light level, wherein said power source, motion sensor, illumination means, time delay means and light sensor are all connected by the electrical circuit, such that when the light sensor detects darkness, the electrical circuit causes the illumination means to illuminate and when the light sensor does not detect darkness, the electrical circuit turns off the illumination means after a time delay set by the time delay means.

21. The lighting device of claim 1, further comprising an on/off switch, wherein the switch is an on and off control for the illumination means.

22. The lighting device of claim 1, further comprising a dimming switch, wherein the dimming switch controls the brightness of the illumination means.

23. The lighting device of claim 1, further comprising a resistor or rheostat device to control the brightness of the illumination means.

24. The lighting device of claim 1, wherein at least one of the housing, power source, electrical circuit, motion sensor, illumination means and time delay means is hermetically sealed or otherwise waterproof.

25. The lighting device of claim 6, further comprising an AC transformer, wherein the AC power may be shared between the lighting device and a second device.

26. The lighting device of claim 25, wherein the second device is a fixed electronic device.

27. The lighting device of claim 25, wherein the second device is a portable electronic device.

28. The lighting fixture of claim 25, further comprising a first on/off switch, wherein the first switch is an on and off control for the illumination means.

29. The lighting fixture of claim 25, further comprising a second on/off switch, wherein the second switch is an on and off control for the second device.

30. The lighting fixture of claims 25, further comprising a first/second switch, wherein the switch is a control for the illumination means or the second device.

31. The lighting fixture of claim 30, further comprising an on/off switch, wherein when the first/second switch is set to control the illumination means, the on/off switch is an on and off control for the illumination means and, wherein when the first/second switch is set to control the second device, the on/off switch is an on and off control for the second device.

32. The lighting fixture of claim 30, wherein when the switch is set on the illumination means, the power supplied by the power source is lower than when the switch is set on the second device.

33. A method of providing motion actuated light comprising:
connecting a power source, motion sensor, illumination means and time delay means by an electrical circuit such that when the motion sensor detects motion, the electrical circuit causes the illumination means to illuminate, and when the motion sensor does not detect motion, the electrical circuit turns off the illumination means after a time delay set by the time delay means; and
containing at least one of the power source, electrical circuit, motion sensor, illumination means and time delay means within a housing.

34. The lighting method of claim 33, wherein the power generated by the power source is direct current (DC).

35. The lighting method of claim 34, wherein the power source is at least one battery.

36. The lighting method of claim 35, wherein the at least one battery is selected from a group consisting of AAA, AA, C, D, 9V, nickel cadmium, nickel metal hydride, lithium ion, sealed lead acid or combinations thereof.

37. The lighting method of claim 35, wherein the at least one battery is rechargeable.

38. The lighting method of claim 33, wherein the power generated by the power source is alternating current (AC).

39. The lighting method of claim 1, further comprising securing the housing to a structure.

40. The lighting method of claim 39, wherein the structure is selected from a group consisting of a building, ceiling, wall, floor, piece of furniture, fixed electronic device, portable electronic device, and components thereof.

41. The lighting method of claim 39, wherein the structure is a lighting fixture.

42. The lighting method of claim 41, wherein the lighting fixture is selected from a group consisting of track-mounted, recessed, and wall-mounted.

43. The lighting method of claim 33, further comprising engaging a mountable cover with the housing, for enclosing the housing.

44. The lighting method of claim 43, wherein the mountable cover is made of a material selected from the group consisting of transparent, colored, frosted, textured, flat, clear, opaque and combinations thereof.

45. The lighting method of claim 43, wherein the mountable cover includes a doping of phosphorescent material.

46. The lighting method of claim 38, further comprising converting the AC power generated by the power source to DC power.

47. The lighting method of claim 38, further comprising charging a DC power source with the AC power generated by the power source.

48. The lighting method of claim 33, wherein the illumination means is selected from a group consisting of incandescent bulbs, light emitting diodes (LEDs), vacuum bulbs, krypton bulbs, halogen bulbs, fluorescent lighting, compact fluorescent lighting, high density definition lighting and quartz halogen lighting.

49. The lighting method of claim 33, wherein the illumination means produces low level illumination.

50. The lighting method of claim 33, wherein the illumination means further includes a means for fading, wherein the illumination decreases from on to off, or increases from off to on.

51. The lighting method of claim 33, further comprising connecting a light sensor for detecting ambient light level, wherein the power source, motion sensor, illumination means, time delay means and light sensor are connected by the electrical circuit such that when the motion sensor detects motion and the light sensor detects darkness, the electrical circuit causes the illumination means to illuminate and when the motion sensor does not detect motion or the light sensor does not detect darkness, the electrical circuit turns off the illumination means after a time delay set by the time delay means.

52. The lighting method of claim 33, further comprising connecting a light sensor for detecting ambient light level, wherein said power source, motion sensor, illumination means, time delay means and light sensor are all connected by the electrical circuit, such that when the light sensor detects darkness, the electrical circuit causes the illumination means to illuminate and when the light sensor does not detect darkness, the electrical circuit turns off the illumination means after a time delay set by the time delay means.

53. The lighting method of claim 38, further comprising sharing the AC power between the lighting device and a second device.

54. The lighting method of claim 53, wherein the second device is a fixed electronic device.

55. The lighting method of claim 53, wherein the second device is a portable electronic device.
